(19) United States
(12) Patent Application Publication
(10) Pub. No.: US 2012/0091156 A1
(43) Pub. Date: Apr. 19, 2012

(54) Reusable Beverage Sleeve and Methods of Use Thereof

(76) Inventor: Jae Sang Lee, Denver, CO (US)

(21) Appl. No.: 13/089,034

(22) Filed: Apr. 18, 2011

Related U.S. Application Data
(60) Provisional application No. 61/325,218, filed on Apr. 16, 2010.

(51) Int. Cl. B65D 25/20; B23P 11/00

(52) U.S. Cl. 220/737; 29/428

(57) ABSTRACT

Reusable beverage sleeves and methods of use are disclosed herein. The inventive reusable beverage sleeves can be removably coupled or operatively engaged with a beverage container. The reusable beverage sleeve typically comprises a first section and a second section. The first section includes a pocket with which to store and secure various items. The second section and the first section form a generally tubular sleeve having an upper edge and a lower edge which creates an opening to receive the beverage container of a user's appendage (e.g., a wrist, forearm, ankle, or calf). The first and second sections are typically substantially comprised of a flexible fabric, such as elastic or similar elastomer material.

### CROSS-REFERENCE TO RELATED APPLICATIONS

This application is a nonprovisional patent application of and claims priority to U.S. provisional patent application No. 61/325,218 filed Apr. 16, 2010, the full disclosure of which is incorporated herein by reference. The aforementioned provisional patent application has the same title and named inventor as the present application.

### FIELD OF THE INVENTION

The present invention relates generally to sleeves for beverage containers. More particularly, the present invention relates to multifunctional reusable beverage sleeves.

### BACKGROUND

Sleeves for beverages containers are commonly used for purposes such as safety, protection, and insulation. Most commonly, such sleeves are necessary for hot beverages such as coffee or tea for safety and protection of the user; however, a sleeve can be advantageous for cold beverages as well for providing insulation to the user's hand and keeping the beverage cool. Most, if not all, sleeves for beverage containers are disposable, typically comprised of cardboard or cheap plastic. It is estimated that each year 1.1 billion single serve coffee cups with accompanying disposable sleeves are discarded.

Reusable products are becoming increasingly popular for environmentally conscious individuals as well as those who just prefer not to make unnecessary waste. Most often, reusable products are adopted when they provide a multifunctional purpose, not just as a simple replacement of a “like for like” disposable counterpart. Heretofore, there remains a need for a reusable beverage sleeve as a viable alternative to the disposable sleeves, which create a significant amount of unnecessary waste.

### BRIEF DESCRIPTION OF THE FIGURES

FIG. 1 is a front perspective view of a reusable beverage sleeve on a beverage container according to a first embodiment.

FIG. 2 is side perspective view of a reusable beverage sleeve on a beverage container where a seam couples a first section to a second section according to a first embodiment.

FIG. 3 is a front plan view of a reusable beverage sleeve according to a second embodiment.

FIG. 4 is a rear plan view of a reusable beverage sleeve according to a second embodiment.

FIG. 5 is a perspective view of items in a pocket of a reusable beverage sleeve on a beverage container according to an embodiment.

FIG. 6 is a perspective view of a reusable beverage sleeve on a user's forearm with items being placed in a pocket of the reusable beverage sleeve according to an embodiment.

### DETAILED DESCRIPTION

Embodiments of the present invention comprise reusable beverage sleeves adapted to extend around beverage containers of various sizes and shapes. The reusable beverage sleeve typically comprises a first section having a pocket coupled to a second section completing a generally tubular sleeve configuration. The reusable beverage sleeve can be slightly frustoconical to receive similarly shaped beverage containers such as, but not limited to, a paper coffee cup. However, some embodiments can be generally straight to receive a water bottle, thermos, or the like. Other embodiments of the reusable beverage sleeves can also include a configurable seam adapted to adjust the general diameter of the reusable beverage sleeves. Embodiments of the reusable beverage sleeve are typically constructed from a flexible material such as, but not limited to, a durable and lightweight elastic or similar elastomer material.

A person owning a reusable beverage sleeve having a pocket is far more likely to utilize and retain such an environmentally friendly product because of the value added functions and multiple uses of a reusable sleeve having a pocket. The multifunctional aspects of the reusable beverage sleeve include storing items in the pocket and using the reusable beverage sleeve as an attachment to one's arms or legs to store items while walking, running, or exercising.

A method of using a reusable beverage sleeve and carrying items therewith, exemplifying some of the multifunctional aspects, comprises: (i) providing a reusable beverage sleeve having at least one pocket; (ii) inserting one or more items into the pocket of the reusable beverage sleeve; (iii) placing the reusable beverage sleeve on a beverage container; (iv) removing the reusable beverage sleeve from the beverage container; and (v) placing the reusable beverage sleeve on an appendage of the user.

### Terminology

The terms and phrases as indicated in quotes (“ ”) in this section are intended to have the meaning ascribed to them in this Terminology section applied to them throughout this document including the claims unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive rather the term is inclusive meaning: either or both.

References in the specification to “one embodiment”, “an embodiment”, “an alternative embodiment” and similar phrases mean that a particular feature, structure, or characteristic described in connection with the embodiment is included in at least an embodiment of the invention. The appearances of the phrase “in one embodiment” in various places in the specification are not necessarily all meant to refer to the same embodiment.

The term “couple” or “coupled” as used in this specification and the appended claims refers to either an indirect or direct connection between the identified elements, components or objects. Often the manner of the coupling will be related specifically to the manner in which the two coupled elements interact.

The term “removable,” “removably coupled,” “readily removable,” and similar terms, as used in this specification and appended claims, refer to structures that can be uncoupled from an adjoining structure with relative ease (i.e., non-destructively and without complicated or time consuming process), and can also be readily reattached or coupled to the previously adjoining structure.

Directional and/or relationary terms such as, but not limited to, left, right, top, bottom, vertical, horizontal, back, front and lateral are relative to each other and are dependent on the specific orientation of an applicable element or article, and are used accordingly to aid in the description of the various embodiments and are not necessarily intended to be construed as limiting.

As applicable, the terms “about” and “generally” as used herein unless otherwise indicated mean a margin of +−20%. Also, as applicable, the term “substantially” as used herein unless otherwise indicated means a margin of +−10%. Concerning angular measurements, “about” or “generally” refer to +−10 degrees and “substantially” refers to +−5.0 degrees unless otherwise indicated. It is to be appreciated that not all uses of the above terms are quantifiable such that the referenced ranges can be applied.

### Exemplary Embodiments of a Reusable Beverage Sleeve

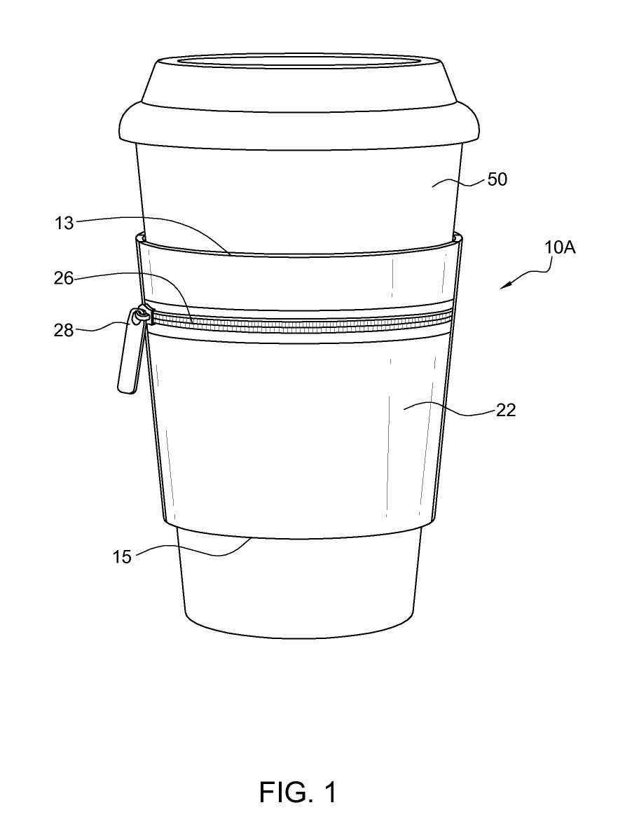

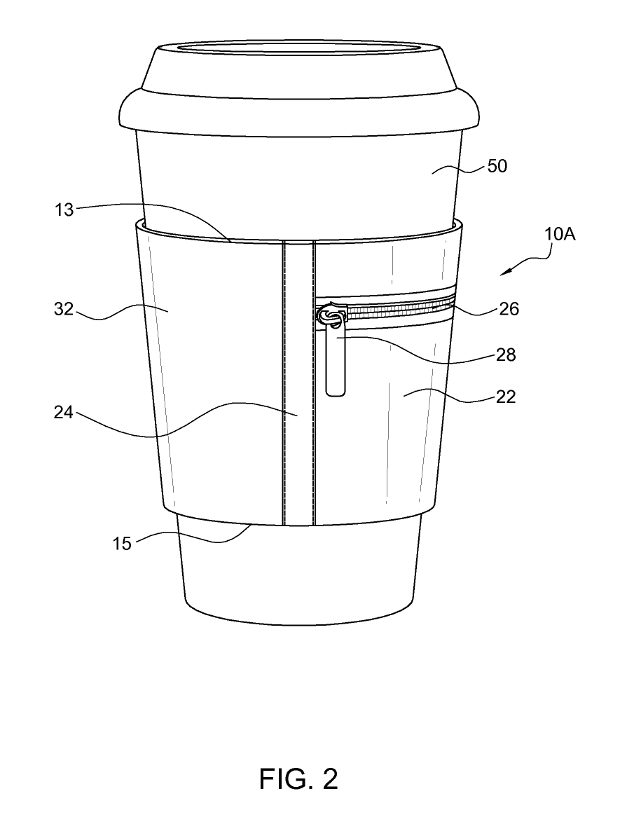

Exemplary embodiments of a reusable beverage sleeve are illustrated in FIGS. 1 through 4. Referring to FIGS. 1 and 2, a first embodiment reusable beverage sleeve 10A is shown engaged around a beverage container 50. The first embodiment reusable beverage sleeve 10A can be removably coupled to and engaged with the beverage container 50 by longitudinally sliding the first embodiment reusable beverage sleeve 10A over a top or bottom (more typically the bottom) end of the beverage container 50. It is to be appreciated that various embodiments of the reusable beverage sleeve are adapted to fit various sizes of beverage containers.

Typically, the first embodiment reusable beverage sleeve 10A includes a first section and a second section coupled together to form a flexible (and, in many implementations, stretchable) tubular band or sleeve. As best illustrated with reference to FIG. 2, the first section of the first embodiment reusable beverage sleeve 10A comprises a pocket 22 which can be coupled to the second section 32 by one or more seams 24 extending generally longitudinally with respect to the beverage container 50 when the first embodiment reusable beverage sleeve 10A is operatively engaged therewith.

An internal surface of the reusable first embodiment reusable beverage sleeve 10A is configured to contact at least a portion of the outer surface of beverage container 50 and extend circumferentially therearound. An outer surface of the first embodiment reusable beverage sleeve 10A similarly extends circumferentially around the beverage container 50, but faces radially away from the beverage container 50.

The pocket 22 is accessible from the outer surface of the reusable beverage sleeve 10 and is defined by an inner lining and an outer lining coupled together at their edges creating an interior cavity having an opening. In a non-limiting implementation, the pocket 22 is a generally rectangular or trapezoidal shape defined by one or more seams 24 coupling the inner lining with the outer lining of the pocket 22. The seams 24 defining the latitudinal width of the pocket 22 also define the second section or rear area of the first embodiment reusable beverage sleeve 10A. The pocket 22 can extend from an upper edge 13 to a lower edge 15 of the first embodiment reusable beverage sleeve 10A where the inner lining and outer lining of the pocket 22 can be coupled by one or more seams 24. However, it is to be appreciated that the pocket may not fully extend from the upper edge to the lower edge of the reusable beverage sleeve in some embodiments. Moreover, other embodiments of the reusable beverage sleeve may include more than one pocket.

The opening of the pocket 22 provides the ability to place and secure place items into the interior cavity of the pocket 22. The opening is typically a sealable seam, such as a zipper 26 having a slider 28 operatively coupled thereto. However, the sealable seam may comprise any suitable configuration adapted to seal and unseal or open and close such as, but not limited to, hook and loop attachment strips, buttons, snaps, and an interlocking seal type closure. In one embodiment, the pocket can include a substantially waterproof interior cavity having a substantially waterproof interlocking seal type closure. Moreover, in at least one embodiment, the pocket may not include a means of sealing and unsealing the interior cavity. For example, the opening may only comprise a slit in the pocket thereby providing access to the interior cavity.

The upper edge 13 and the bottom edge 15 of the first embodiment reusable beverage sleeve 10A are typically substantially parallel to each other when the reusable beverage sleeve 10 is wrapped around or operatively engaged with the beverage container 50. Generally, a longitudinal distance from the upper edge 13 to the lower edge 15 is approximately between 7 cm to 9 cm. Additionally, the general diameter of the first embodiment reusable beverage sleeve 10A at the upper edge and lower edges 13, 15 in a generally circular and tubular yet unbiased configuration can be approximately between 7 cm to 9 cm. In a biased or stretched configuration when operatively engaged with a beverage container or a person's appendage such as an arm or a leg, the general diameter of upper edge and lower edges 13, 15 may increase.

Such an embodiment is typically designed for use with small, medium, and large disposable paper coffee cups. However, embodiments having various longitudinal distances and general diameters are contemplated. Typically, but not necessarily, the general diameter of the upper edge 13 of the first embodiment reusable beverage sleeve 10A is slightly larger than the general diameter of the lower edge 15 when in a generally circular and tubular yet unbiased configuration.

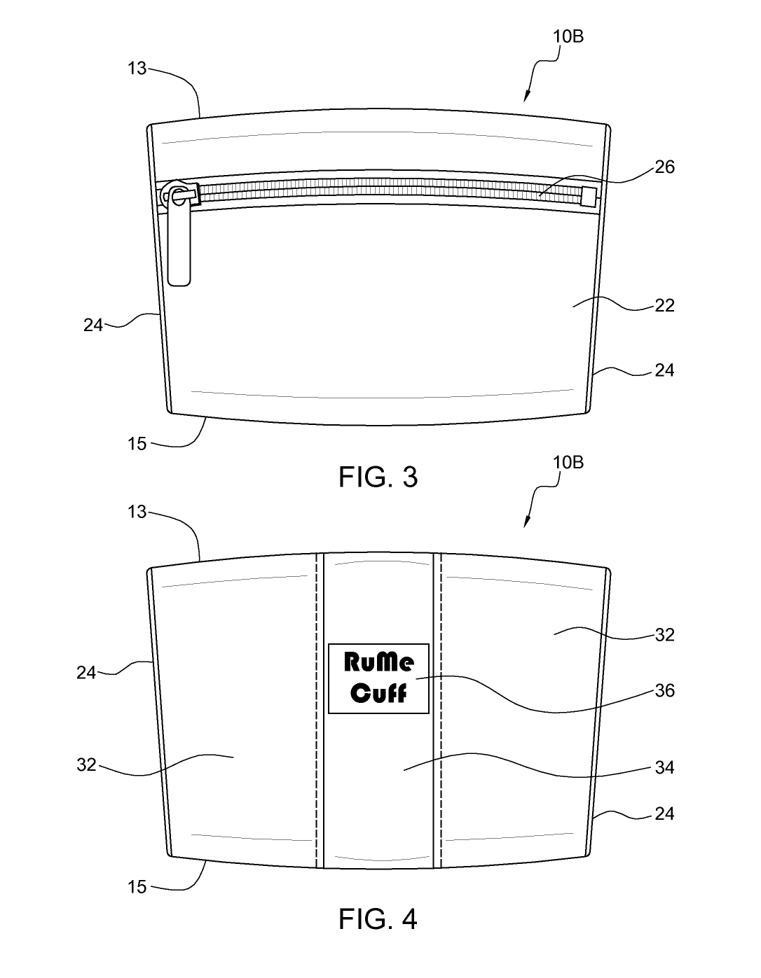

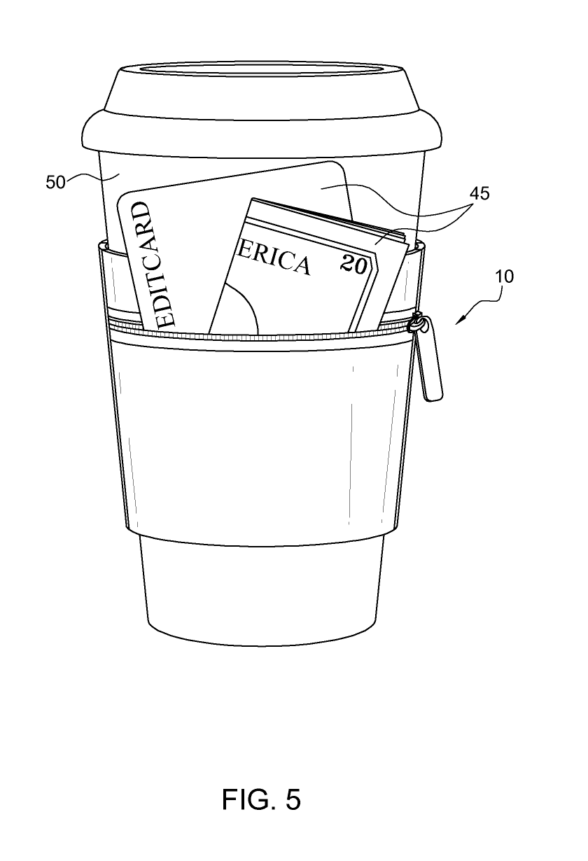

Referring now to FIGS. 3 and 4, a second embodiment reusable beverage sleeve 10B is illustrated. Typically, the general diameter of the upper edge 13 of the second embodiment reusable beverage sleeve 10B is approximately equal to the general diameter of the lower edge 15 when in a generally circular and tubular yet unbiased configuration. Generally, the longitudinal distance from the upper edge 13 second embodiment reusable beverage sleeve 10B to the lower edge 15 is approximately between 7 cm to 9 cm. Moreover, the general diameter of the upper edge 13 of the second embodiment reusable beverage sleeve 10B is approximately equal to the general diameter of the lower edge 15 when in a generally circular and tubular yet unbiased configuration.

The general diameter of the second embodiment reusable beverage sleeve 10B at the upper and lower edges 13, 15 in a generally circular and tubular yet unbiased configuration can also be approximately between 7 cm to 9 cm. When substantially flattened as illustrated in FIGS. 3 and 4, the second embodiment reusable beverage sleeve 10B can have a length of approximately 10 to 12 cm along the upper and lower edges 13, 15. Such an embodiment may be similarly used with small, medium, and large disposable paper coffee cups. However, the second embodiment reusable beverage sleeve 10B can be used with an elongated water bottle or thermos whereby the radius of curvature is relatively equal (i.e., relatively cylindrical) throughout the length of the beverage container.

The second embodiment reusable beverage sleeve 10B similarly includes a first section and a second section coupled together to form a flexible (and, in many implementations, stretchable) tubular band or sleeve. The first section of the second embodiment reusable beverage sleeve 10B comprises a pocket 22 which can be coupled to the second section 32 by one or more seams 24 extending generally longitudinally.

The second embodiment reusable beverage sleeve 10B includes an internal surface configured to contact at least a portion of the outer surface of a beverage container (similarly to the first embodiment) and extend circumferentially therearound. An outer surface of the second embodiment reusable beverage sleeve 10B faces radially away from the beverage container when operatively engaged therewith.

A pocket 22 of the second embodiment reusable beverage sleeve 10B is accessible from the outer surface and is defined by an inner lining and an outer lining coupled together at their edges creating an interior cavity having an opening. The pocket 22 is a generally rectangular or trapezoidal shape defined by one or more seams 24 coupling the inner lining with the outer lining of the pocket 22. One or more seams 24 defining the latitudinal width of the pocket 22 also define the second section or rear area of the second embodiment reusable beverage sleeve 10B. The pocket 22 can extend from an upper edge 13 to a lower edge 15 of the second embodiment reusable beverage sleeve 10B where the inner lining and outer lining of the pocket 22 can be coupled by one or more seams 24.

Additionally, the second embodiment reusable beverage sleeve 10B can also comprise a print portion 34 disposed on the second section. The print portion 34 can be attached to the second portion of the second embodiment reusable beverage sleeve 10B by longitudinal seams, for instance. Some companies may wish to have their brand associated with the second embodiment reusable beverage sleeve 10B and as such the print portion 34 is adapted to receive and display a graphic or logo 36 and is typically comprised of a woven fabric. Moreover, the print portion 34 can serve to hide a larger seam of the second section 32 when the internal surface is comprised of a single piece of flexible material. For example, the second embodiment reusable beverage sleeve 10B can be constructed of a first substantially rectangular piece of elastic or elastic material that constitutes the internal surface of the first section and the second section 32. The pocket 22 of the first section can be formed by a second piece of substantially rectangular piece of elastic or elastic material approximately half of the width (latitudinal or horizontally) of the first substantially rectangular piece. The second piece of substantially rectangular piece can include a sealable seam and be coupled to the first substantially rectangular piece by one or more seams 24.

The flexible material from which the first and second reusable beverage sleeves 10A, 10B is mainly comprised is typically elastic and/or similar elastomer materials. The elastic and/or similar elastomer materials utilized are typically lightweight and durable. However, it is to be appreciated that other or additional suitable materials can be used, particularly those that are adapted to provide some thermal insulation. In some embodiments, a woven fabric or a non-woven fabric capable of being machine washable can be used for portions of the first and second reusable beverage sleeves 10A, 10B. Certain embodiments can be constructed from films and fabrics comprising polyethylene terephthalate, polyfins, and/or fluorinated polymers, for example.

The second section 32 of the first and second reusable beverage sleeves 10A, 10B is typically, but not necessarily, comprised of the same material as the first section/pocket 22. For example, an embodiment constructed from different flexible materials may include the first section/pocket 22 being comprised of flexible, reinforced 100% polyester approximately 180 denier thick and the second section 32 being comprised of elastic. Hence, the first section/pocket 22 can more easily encompass various designs and colors and the second section 32 can be varied in length to be adapted to a wide variety of beverage container diameters.

It should be noted, however, that the principles encompassed by embodiments of the reusable beverage sleeve are not limited to any specific type of fabric, material, and/or construction thereof.

### An Exemplary Method of Using a Reusable Beverage Sleeve

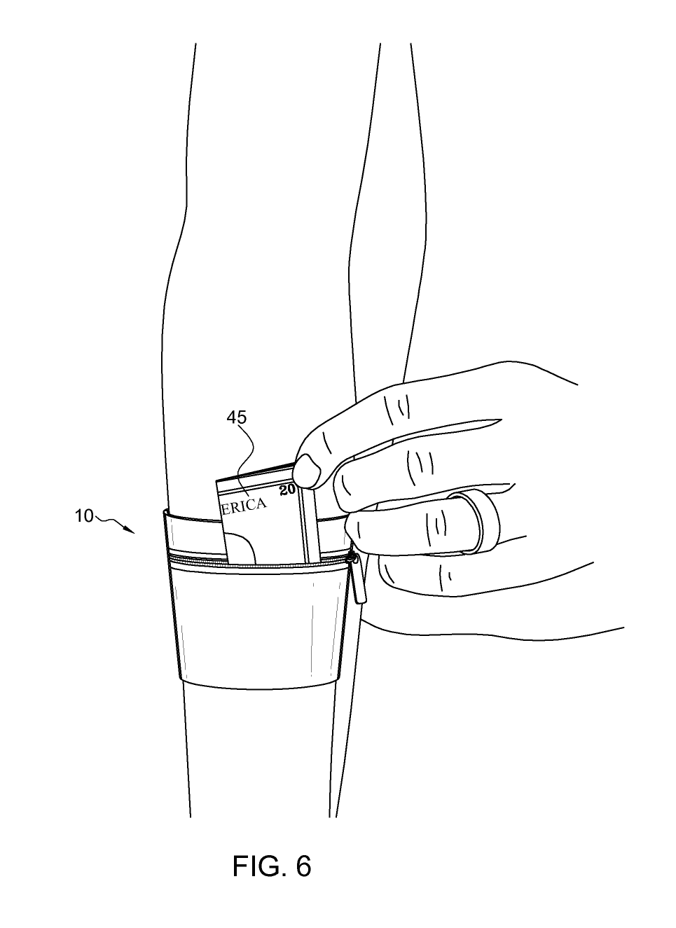

An exemplary method of using a reusable beverage sleeve and carrying items therewith is described herein. It is to be appreciated that various embodiments of the reusable beverage sleeve such as, but not limited to, the first and second reusable beverage sleeves 10A, 10B can be used in conjunction with the exemplary method described herein depending on the use and context of the specific situation (e.g., going to the coffee shop, heading to the gym with an energy drink, and going on a walk, hike, or run with a water bottle). The exemplary method is best illustrated with reference to FIGS. 5 and 6.

The exemplary method comprises a first operation of providing a reusable beverage sleeve 10 having at least one pocket. A second operation of the exemplary method comprises inserting one or more items 45 into the pocket of the reusable beverage sleeve 10. The one or more items 45 can be any item that a user may wish to carry with him or her. Non-limiting examples of the one or more items are coins, cash, credit cards, business cards, note cards, and keys.

Next, a third operation comprises placing the reusable beverage sleeve 10 on a beverage container. A fourth operation comprises removing the reusable beverage sleeve 10 from the beverage container and placing it on an appendage of the user. For example, the user might place the reusable beverage sleeve on his or her wrist, forearm, bicep, ankle, or calf.

Additionally, a fifth operation of turning the reusable beverage sleeve inside out can be performed such that the internal surface becomes externally facing and the outer surface now becomes inwardly facing toward the user's appendage. Thus, the security of the one or more items 45 contained in the pocket of the reusable beverage sleeve 10 may be increased. Such an operation is particularly useful for embodiments of the reusable beverage sleeve 10 that do not have a sealable opening to the pocket.

### Alternative Embodiments and Variations

The various embodiments and variations thereof, illustrated in the accompanying figures and/or described herein, are merely exemplary and are not meant to limit the scope of the invention. It is to be appreciated that numerous other variations of the invention have been contemplated, as would be obvious to one of ordinary skill in the art, given the benefit of this disclosure. All variations of the invention disclosed in this provisional application are intended and contemplated to be within the scope of the invention.

For example, some embodiments of the reusable beverage sleeve can comprise more than one pocket. In other embodiments can comprise a clip or other attachment means with which to couple a user's keys, attachable cards, or other such items.

In embodiments of the reusable beverage sleeve designed for cold beverages may include a thicker inner layer of insulating material. Moreover, numerous shapes and sizes of embodiments of the reusable beverage sleeve, which are adapted to fit various beverage containers such as, but not limited to, glass or plastic bottles, aluminum cans, thermoses, and Nalgene® and similar type bottles are contemplated under the present disclosure.

In yet other embodiments, the reusable beverage sleeve can have an adjustable diameter by including at least one configurable or removably coupled seam where the first section and the second section meet (e.g., with use of a plurality or elongated hook and loop attachment assembly).

I claim:

1. A reusable beverage sleeve for removably coupling to a beverage container, the reusable beverage sleeve comprising:
a first section, the first section having a pocket; and
a second section, the second section and the first section forming a generally tubular sleeve having an upper edge and a lower edge;
wherein the first section and second section are substantially comprised of a flexible fabric.

2. The reusable beverage sleeve of claim 1, wherein the reusable beverage sleeve is washable.

3. The reusable beverage sleeve of claim 1, wherein the flexible fabric is lightweight elastic.

4. The reusable beverage sleeve of claim 1, wherein the pocket includes a sealable seam.

5. The reusable beverage sleeve of claim 4, wherein the sealable seam comprises a zipper having a slider operatively coupled thereto.

6. The reusable beverage sleeve of claim 1, wherein the pocket comprises approximately 50 percent of an outer surface area of the reusable beverage sleeve.

7. The reusable beverage sleeve of claim 1, wherein the upper edge and the bottom edge are substantially parallel to each other when the reusable beverage sleeve is operatively engaged with the beverage container.

8. The reusable beverage sleeve of claim 1, wherein a longitudinal distance from the upper edge to the lower edge is approximately between 7 cm to 9 cm.

9. The reusable beverage sleeve of claim 1, wherein a general diameter of the reusable beverage sleeve at the upper edge and lower edge is approximately between 7 cm to 9 cm.

10. The reusable beverage sleeve of claim 1, wherein an upper general diameter of the upper edge is greater than a lower general diameter of the lower edge.

11. The reusable beverage sleeve of claim 1, wherein an upper general diameter of the upper edge is approximately equal to a lower general diameter of the lower edge.

12. The reusable beverage sleeve of claim 1 further comprising a print portion disposed on the second section.

13. The reusable beverage sleeve of claim 12, wherein the print portion includes a one of a logo or graphic thereon.

14. The reusable beverage sleeve of claim 12, wherein the print portion is formed from a different material from the majority of the first and second section.

15. The reusable beverage sleeve of claim 1 further comprising a configurable seam adapted to change a general diameter of at least a portion of the reusable beverage sleeve.

16. The reusable beverage sleeve of claim 16, wherein the configurable seam is comprised of a hook and loop assembly.

17. A washable and wearable reusable beverage sleeve for removably coupling to a beverage container, the reusable beverage sleeve comprising:
a first substantially rectangular piece of elastic and having a sealable seam thereon;
a second substantially rectangular piece of elastic being longer than the first substantially rectangular piece of elastic; and
a longitudinal seam coupling a first end of the second substantially rectangular piece of elastic to a second end of second substantially rectangular piece of elastic whereby a generally tubular sleeve is formed having an upper edge and a lower edge creating an opening for operatively engaging the beverage container;
wherein a pocket is formed by coupling the first substantially rectangular piece of elastic to the second substantially rectangular piece of elastic first section by one or more seams.

18. The washable and wearable reusable beverage sleeve of claim 17 further comprising a longitudinal piece of woven fabric for covering the longitudinal seam, the longitudinal piece of woven fabric having a one of a logo or graphic thereon.

19. A method of using a reusable beverage sleeve, the method comprising:
providing a reusable beverage sleeve having at least one pocket;
inserting one or more items into the pocket of the reusable beverage sleeve;
placing the reusable beverage sleeve on a beverage container; and
placing the reusable beverage sleeve on an appendage of the user.

20. The method of claim 19 further comprising:
turning the reusable beverage sleeve inside out prior to said placing the reusable beverage sleeve on an appendage of the user.
